(19) United States
(12) Patent Application Publication
(10) Pub. No.: US 2012/0127093 A1
(43) Pub. Date: May 24, 2012

(54) TOUCH PAD AND ELECTRONIC DISPLAY DEVICE APPLIED WITH THE SAME

(75) Inventors: Ching-Hsuan HUANG, Taipei (TW); Po-Tsang LEE, Taipei (TW); Meng-Chen TSAI, Taipei (TW); Ching-Fu HUANG, Taipei (TW); Ching-Yi CHEN, Taipei (TW); Yuan-Chi TSAI, Taipei (TW)

(73) Assignee: INVENTEC CORPORATION, Taipei (TW)

(21) Appl. No.: 13/095,064

(22) Filed: Apr. 27, 2011

(30) Foreign Application Priority Data
Nov. 23, 2010 (CN) 201020624543.8

(51) Int. Cl. G06F 3/041

(52) U.S. Cl. 345/173

(57) ABSTRACT

A touch pad disposed in an electronic display device is provided. The touch pad includes a sliding region, a first virtual-key region and a second virtual-key region both adjacent to the sliding region, a first vibrator and a second vibrator. The sliding region are capable of sensing a dragging action, the first virtual-key region and the second virtual-key region are capable of sensing a pressing action, and the second virtual-key region corresponds to one side of the first virtual-key region. The first vibrator and the second vibrator are respectively disposed underneath the first virtual-key region and the second virtual-key region. When the first virtual-key region senses the pressing action, the first vibrator generates vibration. When the second virtual-key region senses the pressing action, the second vibrator generates vibration.

This application claims the benefit of People's Republic China application Serial No. 201020624543.8, filed Nov. 23, 2010, the subject matter of which is incorporated herein by reference.

### BACKGROUND OF THE DISCLOSURE

1. Field of Disclosure

The disclosure relates in general to a touch pad and an electronic display device applied with the same, and more particularly to a touch pad capable of enhancing the user's hand feel and an electronic display device applied with the same.

2. Description of the Related Art

With the advance in technology, electronic products, particularly, portable electronic devices have become indispensable to modern people in their everydayness and business as well. Notebook portable electronic devices, having the advantages of lightweight, slimness and compactness as well as excellent portability and convenience, have already gained great popularity and gradually replace desktop portable electronic devices.

Normally, a mechanical touch button is added to a side of the touch pad used in a notebook portable electronic device to replace an external mouse, and the user can activate the mouse-click function by way of pressing the touch button. In practical application, the touch pad itself can activate the mouse-click function by way of clicking. However, the user can only observe the response shown on the display screen to make sure whether the clicking is effective. Moreover, in order to have enough sliding space, the touch pad must have a certain size for operation by the user. Also, a certain space is required for the mechanical touch button and its supporting mechanism in the conventional touch pad design, and those mechanical elements would occupy a considerable space in the electronic device.

### SUMMARY OF THE DISCLOSURE

The disclosure is directed to a touch pad and an electronic display device applied with the same, which improve the user's hand feel by way of vibration through a virtual-key region with a vibrator and save the space which would otherwise be occupied by conventional mechanical touch button.

According to a first aspect of the present disclosure, a touch pad includes a sliding region, a first virtual-key region and a second virtual-key region both adjacent to the sliding region, a first vibrator and a second vibrator. The sliding region is capable of sensing a dragging action, the first virtual-key region and the second virtual-key region are capable of sensing a pressing action, and the second virtual-key region is positioned at one side of the first virtual-key region. The first vibrator and the second vibrator are respectively disposed underneath the first virtual-key region and the second virtual-key region. When the first virtual-key region senses the pressing action, the first vibrator generates vibration. When the second virtual-key region senses the pressing action, the second vibrator generates vibration.

According to a second aspect of the present disclosure, an electronic display device is provided. The electronic display device includes a display screen, and an input system electrically connected to the display screen. The input system has a touch pad as disclosed in the first aspect of the disclosure.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 shows an electronic display device according to an embodiment of the disclosure;

FIG. 2 shows a touch pad according to an embodiment of the disclosure;

FIG. 3 shows the use of the touch pad according to an embodiment of the disclosure; and

FIG. 4 shows a flowchart of a touch method of a touch pad according to an embodiment of the disclosure.

### DETAILED DESCRIPTION OF THE DISCLOSURE

A number of embodiments are disclosed below for elaborating the details of the disclosure. However, the embodiments disclosed below are for detailed description of the disclosure, not for limiting the scope of protection of the disclosure.

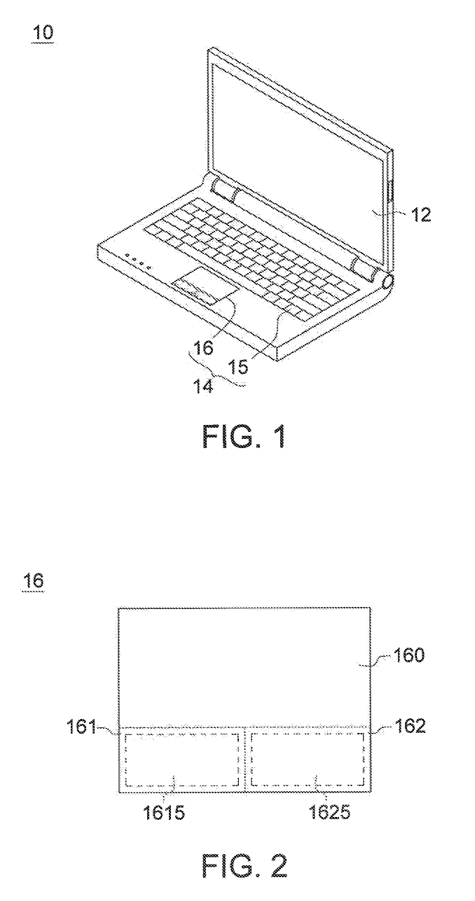

Referring to FIG. 1, an electronic display device according to an embodiment of the disclosure is shown. The electronic display device 10 includes a display screen 12 and an input system 14 which are electrically connected together, wherein the input system 14 has a keypad 15 and a touch pad 16.

The exemplification in FIG. 1 shows that the touch pad 16 of an embodiment of the disclosure is used in a notebook computer. However, the touch pad 16 of an embodiment of the disclosure can be applied in other types of electronic display devices such as a tablet PC, and no particular application limitations of the disclosure.

Referring to FIG. 2, a touch pad according to an embodiment of the disclosure is shown. In an embodiment, the touch pad 16 is divided into three regions, namely, a sliding region 160, a first virtual-key region 161 and a second virtual-key region 162. The first virtual-key region 161 and the second virtual-key region 162 are both adjacent to the sliding region 160, and the second virtual-key region 162 corresponds to one side of the first virtual-key region 161. The sliding region 160 is capable of sensing a dragging action, while the first virtual-key region 161 and the second virtual-key region 162 are capable of sensing a pressing action. In an embodiment, the sliding region 160, the first virtual-key region 161 and the second virtual-key region 162 can all be designed as regions for sensing the dragging action. The first virtual-key region 161 and the second virtual-key region 162 are respectively used as the left button and the right button.

Moreover, the touch pad 16 further includes a first vibrator 1615 and a second vibrator 1625 respectively disposed underneath the first virtual-key region 161 and the second virtual-key region 162. When the first virtual-key region 161 senses the pressing action, the first vibrator 1615 generates vibration. When the second virtual-key region 162 senses the pressing action, the second vibrator 1625 generates vibration. The first vibrator 1615 is electrically connected to the first virtual-key region 161, and the second vibrator 1625 is electrically connected to the second virtual-key region 162. In an embodiment, the first vibrator 1615 and the second vibrator 1625 are electrically isolated from each other.

In an embodiment, when the user's finger slides on the touch pad 16, the display screen 12 will synchronically display a moving cursor as if a mouse is moving. When the user's finger clicks on the first virtual-key region 161 or the second virtual-key region 162, the first virtual-key region 161 or the second virtual-key region 162 senses the pressing action, and the first vibrator 1615 or second vibrator 1625 will generate vibration correspondingly; meanwhile, the mouse-click function is activated. Since the vibrator is disposed underneath the virtual-key region, the user's finger can also feel vibration when the vibrator vibrates. Thus, the user is informed by way of vibration that the mouse-click function is already activated.

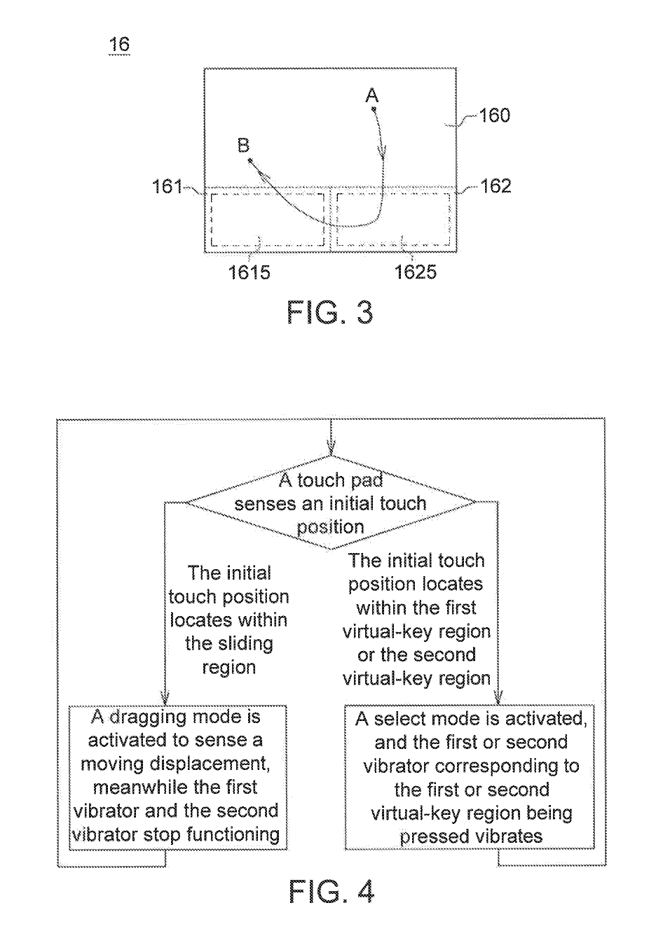

FIG. 3 shows the use of the touch pad according to an embodiment of the disclosure. As indicated in FIG. 3, the user's finger continuously slides along a curve AB from a initial point A to a end point B without loosing contact over the surface of the touch pad 160. The curve AB is the trace of the finger continuously sliding from the initial point A in the sliding region 160, passing through the second virtual-key region 162 and the first virtual-key region 161, and stopping at the end point B of the sliding region 160. When the trace of the curve AB passes through the second virtual-key region 162 and the first virtual-key region 161, the second vibrator 1625 and the first vibrator 1615 do not generate vibration, which could be determined by software or firmware (firmware is the software embedded in the hardware) with appropriate designs.

Referring to FIG. 4, a flowchart of a touch method of a touch pad according to an embodiment of the disclosure is shown. Firstly, an initial touch position is sensed by a touch pad 16. When the user's finger is sensed by the touch pad 16, the software or firmware, first of all, determines which of the sliding region 160, the first virtual-key region 161 and the second virtual-key region 162 does the finger touch within.

In the embodiment, if the initial touch position locates within the sliding region 160, then it is determined that a dragging action is performed, and a dragging mode is activated to sense a moving displacement until the dragging action terminates. After entering the dragging mode, regardless which region to which the finger moves onwards, the finger will not be regarded as pressing any of the two virtual-key regions 161 and 162, and none of the two vibrators 1615 and 1625 will vibrate. Meanwhile, the first virtual-key region 161 and the second virtual-key region 162 are capable of sensing the dragging action, and the dragging action is determined as being interrupted when the finger leaves the touch pad 16. In a practical application, when the touch pad 16 senses the dragging action, the display screen will synchronically display a moving cursor.

If the initial touch position locates within the first virtual-key region 161 or the second virtual-key region 162, then it is determined that a pressing action is performed, and a select mode is activated. After entering the select mode, the one of the first vibrator 1615 and the second vibrator 1625 being pressed will generate vibration. In a practical application, when the touch pad 16 senses the pressing action, a mouse-click function will be activated synchronically.

According to the above disclosure, in practical application, if the user would like to move the cursor, the user can move his/her finger after touching the sliding region 160 to correspond to a moving cursor until the dragging action is interrupted (that is, when the finger is off the touch pad 16), meanwhile, the first vibrator 1615 and the second vibrator 1625 stop vibration. When the user clicks the first virtual-key region 161 or the second virtual-key region 162, the left or the right virtual button is pressed, and the corresponding first vibrator 1615 or second vibrator 1625 will vibrate to inform the user of the click operation being effective.

In the above embodiments of the disclosure, after the touch pad enters the dragging mode, the first virtual-key region 161 and the second virtual-key region 162 together with the sliding region 160 are all used as regions for dragging/sliding, but the disclosure is not limited thereto. In other embodiments, through software design, the first virtual-key region 161 and the second virtual-key region 162 can be merely used as the left virtual button and the right virtual button for entering a pressing mode.

According to the touch pad disclosed in above embodiments of the disclosure, the virtual-key region is combined with a vibrator, which feedbacks to inform the user of the click being effective by way of vibration, not only enhancing the user's hand feel, but also saving the space required for the mechanical touch buttons and its supporting mechanism in the conventional design. Thus, the electronic display device using the touch pad of the present embodiment of the disclosure has more space for strengthening the structure or making the electronic display device thinned and miniaturized.

While the disclosure has been described by way of example and in terms of the embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch pad, comprising:
a sliding region capable of sensing a dragging action;
a first virtual-key region adjacent to the sliding region and capable of sensing a pressing action;
a first vibrator correspondingly disposed underneath the first virtual-key region, wherein the first vibrator generates vibration when the first virtual-key region sensing the pressing action;
a second virtual-key region adjacent to the sliding region, corresponding to one side of the first virtual-key region, and capable of sensing the pressing action; and
a second vibrator correspondingly disposed underneath the second virtual-key region, wherein the second vibrator generates vibration when the second virtual-key region sensing the pressing action.

2. The touch pad according to claim 1, wherein the first vibrator is electrically connected to the first virtual-key region, and the second vibrator is electrically connected to the second virtual-key region.

3. The touch pad according to claim 1, wherein the first vibrator and the second vibrator are electrically isolated from each other.

4. The touch pad according to claim 1, wherein when the sliding region senses the dragging action, a dragging mode is activated, meanwhile the first virtual-key region and the second virtual-key region are capable of sensing the dragging action, and the first vibrator and the second vibrator stop functioning until the dragging action terminates.

5. The touch pad according to claim 1, wherein when the first vibrator or the second vibrator generates vibration, a mouse-click function is activated synchronically.

6. An electronic display device, comprising:
a display screen; and
an input system electrically connected to the display screen, the input system having a touch pad, and the touch pad comprising;
a sliding region capable of sensing a dragging action;
a first virtual-key region adjacent to the sliding region and capable of sensing a pressing action;
a first vibrator correspondingly disposed underneath the first virtual-key region, wherein the first vibrator generates vibration when the first virtual-key region sensing the pressing action;
a second virtual-key region adjacent to the sliding region and corresponding to one side of the first virtual-key region, the second virtual-key region capable of sensing the pressing action; and
a second vibrator correspondingly disposed underneath the second virtual-key region, wherein the second vibrator generates vibration when the second virtual-key region sensing the pressing action.

7. The electronic display device according to claim 6, wherein the first vibrator of the touch pad is electrically connected to the first virtual-key region, and the second vibrator of the touch pad is electrically connected to the second virtual-key region.

8. The electronic display device according to claim 6, wherein the first vibrator and the second vibrator of the touch pad are electrically isolated from each other.

9. The electronic display device according to claim 6, wherein when the sliding region senses the dragging action, a dragging mode is activated, the first virtual-key region and the second virtual-key region are capable of sensing the dragging action, and the first vibrator and the second vibrator stop functioning until the dragging action terminates.

10. The electronic display device according to claim 6, wherein when the sliding region senses the dragging action, the display screen synchronically displays a moving cursor, and when the first or the second virtual-key region senses the pressing action, a select mode is activated.
